(19) United States
(12) Patent Application Publication
(10) Pub. No.: US 2018/0247272 A1
(43) Pub. Date: Aug. 30, 2018

(54) DYNAMIC ALERT SYSTEM

(71) Applicant: International Business Machines Corporation, Armonk, NY (US)

(72) Inventors: Hernan A. Cunico, Holly Springs, NC (US); Asima Silva, Holden, MA (US)

(21) Appl. No.: 15/443,267

(22) Filed: Feb. 27, 2017

(51) Int. Cl. G06Q 10/10; H04L 29/08; G06F 17/27

(52) U.S. Cl. CPC G06Q 10/1093; G06F 17/2785; H04L 67/306

(57) ABSTRACT

User profile data for at least one user can be collected. The user profile data can indicate at least one precursory task related to a future event. The user profile data, including the at least one precursory task, can be analyzed with respect to the future event. A first triggering event can be determined based on the analyzing the user profile data, including the at least one precursory task. The first triggering event can be an occurrence of a first time in advance of the future event. Responsive to detecting the first triggering event, communication of a first alert to the user can be initiated.

### BACKGROUND

The present invention relates to data processing systems, and more specifically, to generating automated alerts regarding events.

The use of electronic calendaring systems is prevalent throughout the world. Oftentimes calendaring systems are components of personal information managers, though some calendaring systems may function as stand-alone applications. An electronic calendaring system provides an electronic version of a calendar, and may also include an address book and/or contact list. In the electronic calendar, a user can schedule events, for example meetings, appointments, tasks, etc. Some electronic calendars allow users to schedule reminder alerts at pre-defined times, for example fifteen minutes prior to a time of a scheduled event. The alerts can notify users as to the upcoming event. For example, a calendaring system can present a pop up window and/or audible notification indicating the scheduled event and the time at which the event is scheduled.

### SUMMARY

A method includes collecting user profile data for at least one user, the user profile data indicating at least one precursory task related to a future event. The method also can include analyzing the user profile data, including the at least one precursory task, with respect to the future event. The method also can include determining, using a processor, a first triggering event based on the analyzing the user profile data, including the at least one precursory task, the first triggering event being an occurrence of a first time in advance of the future event. The method also can include, responsive to detecting the first triggering event, initiating communication of a first alert to the user.

A system includes a processor programmed to initiate executable operations. The executable operations include collecting user profile data for at least one user, the user profile data indicating at least one precursory task related to a future event. The executable operations also can include analyzing the user profile data, including the at least one precursory task, with respect to the future event. The executable operations also can include determining a first triggering event based on the analyzing the user profile data, including the at least one precursory task, the first triggering event being an occurrence of a first time in advance of the future event. The executable operations also can include, responsive to detecting the first triggering event, initiating communication of a first alert to the user.

A computer program includes a computer readable storage medium having program code stored thereon. The program code is executable by a processor to perform a method. The method includes collecting, by the processor, user profile data for at least one user, the user profile data indicating at least one precursory task related to a future event. The method also can include analyzing, by the processor, the user profile data, including the at least one precursory task, with respect to the future event. The method also can include determining, by the processor, a first triggering event based on the analyzing the user profile data, including the at least one precursory task, the first triggering event being an occurrence of a first time in advance of the future event. The method also can include, responsive to detecting the first triggering event, initiating, by the processor, communication of a first alert to the user.

### BRIEF DESCRIPTION OF THE DRAWINGS

FIG. 1 is a block diagram illustrating an example of a computing environment.

FIG. 2 is a flow chart illustrating an example of a method of communicating to a user an alert for a future event.

FIG. 3 is a flow chart illustrating an example of a method of adding a precursory task to user profile data.

FIG. 4 is a block diagram illustrating example architecture for a calendaring server.

FIG. 5 is a block diagram illustrating example architecture for a client device.

### DETAILED DESCRIPTION

The present invention relates to data processing systems, and more specifically, to generating automated alerts regarding events. In accordance with the inventive arrangements disclosed herein, a data processing system can determine at least one alert for one or more future events, and triggering events that initiate presentation of the alerts to a user. Triggering of the alerts can be based on one or more precursory tasks that may need to be completed prior to, or as part of, future events and times it may take the user to complete the precursory task(s). The time(s) needed to complete the precursory task(s) may be based on one or more other people involved in the precursory task(s) and/or the future events, the sentiment and/or emotional state of the user and/or the other person or people, context of the precursory task(s), various locations, including a location of the future event, the user may travel from or to in order to perform the precursory task(s), and so on. Such information can be determined by analyzing the behavior, sentiment, etc. of the user in performing the precursory task(s) for the future event, as well as conditions impacting travel of the user to a location of the future event.

The present arrangements can greatly improve awareness by the user of future events. Moreover, by having greater awareness of future events, the user is much less likely to access processing resources to obtain information regarding future events. Thus, use of the processing resources, and energy used by the processing resources, will be conserved.

Several definitions that apply throughout this document now will be presented.

As defined herein, the term “future event” means an event that is to take place in the future.

As defined herein, the term “past event” means an event that has taken place in the past.

As defined herein, the term “precursory task” means a task that is to be completed by a user in order for the user to participate in a future event.

As defined herein, the term “triggering event” means an event that triggers an alert to be communicated to a user.

As defined herein, the term “client device” means a processing system including at least one processor and memory that requests shared services from a server, and with which a user directly interacts. Examples of a client device include, but are not limited to, a workstation, a desktop computer, a computer terminal, a mobile computer, a laptop computer, a netbook computer, a tablet computer, a smart phone, a personal digital assistant, a smart watch, smart glasses, a gaming device, a set-top box, a smart television and the like. Network infrastructure, such as routers, firewalls, switches, access points and the like, are not client devices as the term “client device” is defined herein.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “computer readable storage medium” means a storage medium that contains or stores program code for use by or in connection with an instruction execution system, apparatus, or device. As defined herein, a “computer readable storage medium” is not a transitory, propagating signal per se.

As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “real time” means a level of processing responsiveness that a user or system senses as sufficiently immediate for a particular process or determination to be made, or that enables the processor to keep up with some external process.

As defined herein, the term “output” means storing in memory elements, writing to display or other peripheral output device, sending or transmitting to another system, exporting, or similar operations.

As defined herein, the term “automatically” means without user intervention.

As defined herein, the term “user” means a person (i.e., a human being).

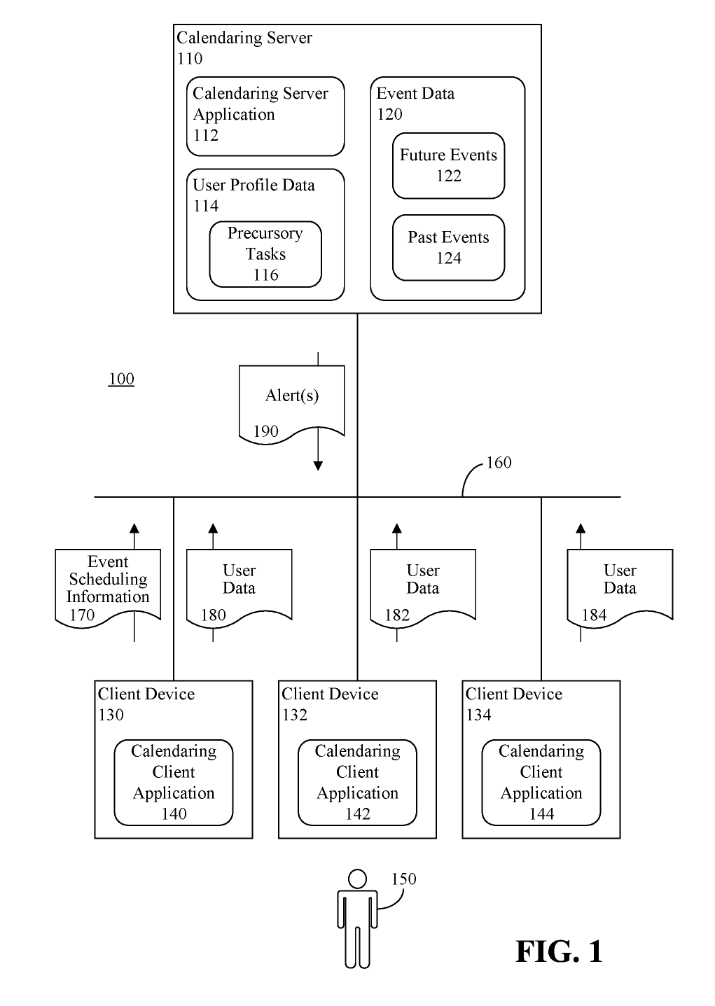

FIG. 1 is a block diagram illustrating an example of a computing environment 100. The computing environment 100 can include a calendaring server 110. The calendaring server 110 can include at least one processor and memory, and can host a calendaring server application 112. The calendaring server 110 also can store user profile data 114. Further, the calendaring server 110 can store event data 120 for future events 122 and past events 124.

The computing environment 100 can include one or more client devices 130, 132, 134. The client device 130 can host a calendaring client application 140. Optionally, one or more of the client devices 132, 134 can host respective calendaring client applications 142, 144. The client device 130 can be communicatively linked to the calendaring server 110 via one or more communication networks 160. A communication network 160 is the medium used to provide communications links between various devices and data processing systems connected together within the computing environment 100. A communication network 160 may include connections, such as wire, wireless communication links, or fiber optic cables. A communication network 160 can be implemented as, or include, any of a variety of different communication technologies such as a wide area network (WAN), a local area network (LAN), a wireless network, a mobile network, a Virtual Private Network (VPN), the Internet, the Public Switched Telephone Network (PSTN), or similar technologies.

Optionally, the client device 132 and/or the client device 134 can be communicatively linked to the calendaring server 110 via the communication network(s) 160. In another arrangement, the client device 132 and/or the client device 134 can be communicatively linked to the calendaring server 110 via the client device 130. In another arrangement, the client device 134 can be communicatively linked to the calendaring server 110 via the client device 132, which can be communicatively linked to the calendaring server 110 via the communication network(s) 160.

By way of example, the client device 130 can be a workstation, desktop computer or mobile computer used by the user 150, the client device 132 can be a smart phone used by the user 150, and the client device 134 can be a smart watch used (e.g., worn) by the user 150. In this example, both the client device 130 and the client device 132 can communicatively link to the calendaring server 110 via the communication network(s) 160. The client device 134 also can communicatively link to the calendaring server 110 via the communication network(s) 160, or can communicatively link to the calendaring server 110 via the client device 132. In this regard, the client device 134 can communicatively link to the client device 132 via personal area network (e.g., Bluetooth®, Bluetooth® low energy (BLE), Zigbee®, and so on).

In operation, a future event 122 including the user 150 as a participant can be scheduled in the calendaring server application 112. For example, using the calendaring client application 140, the calendaring client application 142 or the calendaring client application 144, the user can schedule the future event 122. In illustration, the user 150 can interact with one of the calendaring client applications 140-144 to schedule the future event 122, and the calendaring client application 140-144 can communicate corresponding event scheduling information 170 to the calendaring server application 112. In another example, another user can schedule the future event 122, and invite the user 150 to be a participant in the future event 122. The calendaring server application 112 can communicate an invitation to one or more of the calendaring client applications 140-144, and the user 150 can accept the invitation. In response to the user 150 accepting the invitation, the calendaring client application 140-144 via which the user 150 accepted the invitation can communicate an acceptance to the calendaring server application 112. Further, responsive to the future event 122 including the user 150 as a participant being scheduled, one or more of the calendaring client applications 140-144 can present the event in the user's electronic calendar managed by the calendaring server application 112 and/or one or more of the calendaring client applications 140-144.

In addition, one or more of the client devices 130-134 can communicate to the calendaring server application 112 respective user data 180, 182, 184, which the calendaring server application 112 can store as user profile data 114 for the user 150. Continuing with the previous example, in an arrangement in which the client device 134 is not directly linked to the calendaring server 110 via the communication network(s) 160, the client device 134 can communicate the user data 184 to the calendaring server application 112 via the client device 132.

The user data 180-184 generated by client devices 130-134 which include GPS receivers can include global positioning system (GPS) data indicating respective locations of the client devices 130-134 at various times and corresponding time stamps. In illustration, if the client device 132 is a smartphone, the client device 132 may include a GPS receiver, and the client device 132 can include in the user data 182 GPS coordinates at various times and corresponding time stamps. The user data 180-184 generated by client devices 130-134 also can include data indicating user interactions with the respective client devices 130-134, for example login events, logoff events, events in which applications are open or closed, events in which certain types of data are accessed, user participation in events 122, 124, and so on.

The user data 180-184 also can include a variety of other types of data. For example, the user data 180-184 can include behavioral parameters indicating behaviors of the user 150, sentiment parameters indicating sentiments of the user 150 and/or emotional state parameters indicating emotional states of the user 150.

To generate behavioral parameters, the client devices 130-134 (e.g., the calendaring client applications 40-144) and/or calendaring server application 112 can track behaviors of the user 150 and generate behavioral parameters corresponding to such behaviors. In illustration, one or more of the client devices 130-134 can track an amount of time between when the user 150 receives an alert and the user 150 takes an action responding to the alert, for example performing one or more precursory tasks 116 or workflows.

In illustration, if a precursory task 116 involves the user 150 reaching an expected milestone, the client device 132 and/or calendaring server application 112 can track an amount of time it takes for the user 150 to reach the expected milestone. In other examples, the client device 132 and/or calendaring server application 112 can track an amount of time between when the user 150 receives an alert and when the user 150 leaves a location where the user 150 was located when the user 150 received the alert. In another example, one or more of the client devices 130-134 can identify one or more locations to which the user 150 travels, and a duration of time it takes the user 150 to travel, prior to certain types or categories of events 122, 124. In yet another example, one or more of the client devices 130-134 can track an amount of time between when the user 150 receives an alert and the user 150 joins an online meeting or teleconference using one or more of the client devices 130-134. Moreover, one or more of the client devices 130-134 can identify events 122, 124 for which the user 150 arrives early or begins participating in the events 122, 124 early, events 122, 124 for which the user 150 arrives on time or begins participating in the events 122, 124 on time, and events 122, 124 for which the user 150 arrives late or begins participating late in the events 122, 124.

As noted, the user data 180-184 can include GPS location data and time stamps, as well as data indicating other user interactions with the client devices 130-134. Thus, in other arrangements, the calendaring server application 112 can generate the behavioral parameters based on the location data and time stamps. For example, the calendaring server application 112 can track the amount of time between when the user 150 receives an alert and when the user 150 takes an action responding to the alert, identify various events 124 for which the user 150 is early, on time or late, and so on.

Over time, the calendaring server application 112 can develop one or more behavioral profiles for the user 150 based on the behavioral parameters, and store the behavioral profiles in the user profile data 114 for the user 150. Moreover, the calendaring server application 112 can associate the behavioral profiles with certain types or categories of events 122, 124. In illustration, the calendaring server application 112 can analyze text contained in the event data 120 describing future events 122 and past events 124 by performing natural language processing (NLP) and semantic analysis on the text. Based on the NLP and semantic analysis performed on the text, the calendaring server application 112 can automatically determine a category (e.g., a type) for each future event 122 and past event 124, and generate event contextual parameters for each future event 122 and past event 124.

NLP is a field of computer science, artificial intelligence and linguistics which implements computer processes to facilitate interactions between computer systems and human (natural) languages. NLP enables computers to derive computer-understandable meaning from natural language input. The International Organization for Standardization (ISO) (e.g., ISO/TC37/SC4) publishes standards for NLP. Semantic analysis is the implementation of computer processes to generate computer-understandable representations of natural language expressions. Semantic analysis can be used to construct meaning representations, semantic underspecification, anaphora resolution, presupposition projection and quantifier scope resolution, which are known in the art. Semantic analysis is frequently used with NLP to derive computer-understandable meaning from natural language input. An unstructured information management architecture (UIMA), which is an industry standard for content analytics, may be used by the calendaring server application 112 to implement NLP and semantic analysis.

In illustration, based on the NLP and semantic analysis performed on the text, the calendaring server application 112 can automatically determine other people that may be involved in the future event 122 or past event 124, even if the other people have not received an invitation for the future event 122 or past event 124. For example, if the text contained in the event data 120 indicates “take Johnny to the Dr. Smith,” the calendaring server application 112 can determine that Johnny and Dr. Smith are participants in the event 122, 124, and generate corresponding event contextual parameters with respect to the user 150. Moreover, based on other user profile data 114 of the user 150, the calendaring server application 112 can determine that “Johnny” is a son of the user 150 and Dr. Smith provides medical services to the user's family, and generate corresponding event contextual parameters. Moreover, taking Johnny to the doctor Smith can be a category to which the event 122, 124 is assigned. The calendaring server application 112 can perform the semantic analysis in response to events 122, 124 being scheduled or changed, events 122, 124 being completed, or at periodic time intervals.

As future events 122 come to pass, and thus become past events 124, the calendaring server application 112 can analyze behavioral parameters generated for the user 150 that are related to the events 124 (e.g., the user's participation in the event) and other participants in the events 124. Based on the behavioral patterns and other participants, the calendaring server application 112 can identify one or more precursory tasks 116 the user 150 may perform prior to a future event 122 and contextual information related to the precursory task(s) 116. From such information, the calendaring server application 112 can generate precursory task contextual parameters, with respect to the user 150, for the precursory task(s) 116. The precursory task contextual parameters can indicate, among other things, an order in which the precursory tasks 116 are performed, an amount of time it takes the user 150 to perform each precursory task 116, a nature of the precursory tasks 116, one or more other people involved in each precursory task 116 (who may or may not be participants in a past event 124), and so on. The calendaring server application 112 can identify participants and other people based on the context of the event 124 (e.g., participants invited to or indicated in the past event 124, the category to which the event 124 is assigned, where the event 124 took place, time of day the event 124 took place, day of the week the event 124 took place, time of the year the event 124 took place, etc.).

In illustration, if a past event 124 is a doctor's appointment for a child of the user 150, the calendaring server application 112 can identify behavioral parameters relating to the user 150 getting ready to go to the doctor's appointment (e.g., from the time the user 150 ceases interaction with the client device 132 up until the time the user 150 leaves his or her current location), traveling to the child's school to pick up the child, and traveling from the child's school to the doctor's office. The calendaring server application 112 can analyze the behavioral parameters to determine how long it takes the user 150 to get ready for the doctor's appointment, how long it takes the user 150 to drive to the school and which route the user 150 takes to get there, how long the user 150 is at the school picking up the child, and how long it takes the user 150 to drive from the school to the doctor's office and which route the user 150 takes to get there, how long it takes the user 150 to walk from the car to the doctor's office, etc. These all are precursory tasks 116 that the user 150 may complete prior to participating in the future event 122. Based on the determinations, the calendaring server application 112 can generate precursory task contextual parameters for the precursory tasks 116. The precursory task parameters can indicate a nature of each precursory task 116 and a period of time it takes the user 150 to complete each precursory task 116.

The calendaring server application 112 can store results of such analysis in the user's user profile data 114, for example as a behavior profile, and create a relationship between the behavior profile and the category determined for the event 124. Moreover, the calendaring server application 112 can add to the user profile data 114 (e.g., the behavior profile) the precursory task(s) 116, including the corresponding precursory task contextual parameters, and create in the user profile data 114 a relationship between the precursory task(s) 116 and the category determined for the event 124.

The calendaring server application 112 can access and process the user profile data 114 to determine triggering events. In response to detecting the triggering events, the calendaring server application 112 can initiate alerts 190 for future events 122 assigned the same category. Each alert 190 can be unique to an individual, for example unique to the user 150, and unique to a particular future event 122. Each alert 190 also can be unique to a group of people in involved in the future event 122. Moreover, each alert 190 can be uniquely crafted for specific tasks and/or events based on various parameters.

Each triggering event can be a particular time (i.e., the occurrence of the time) in advance of a corresponding future event 122 at which presentation of a respective alert 190 to the user 150 is to be initiated, taking into consideration the time needed to perform of any precursory tasks 116 that may need to be completed by the user 150 prior to the future event 122. In this regard, the calendaring server application 112 can define each alert 190 to be presented to the user 150 in response to a respective triggering event. In illustration, the calendaring server application 112 can initiate an alert 190 in response to a particular time indicated by a respective triggering event. The alert 190 can be communicated to the user 150 (e.g., to one or more of the client devices 130-134) within a threshold period of time in advance of the future event 122. For example, the alert 190 can be communicated to the user 150 in real time upon occurrence of the triggering event, or within a threshold period of time after the triggering event occurs. Other triggering events can be defined and the present arrangements are not limited in this regard. For example, a triggering event can be defined to be a completion of a precursory task, a circumstance (e.g., a change in a weather, traffic condition and/or air travel condition), and so on.

To generate sentiment parameters indicating sentiments of the user 150, the client devices 130-134 (e.g., the calendaring client applications 40-144) and/or calendaring server application 112 can determine one or more sentiments of the user leading up to a future event 122, for example of threshold period of time prior to the future event 122. For example, the client devices 130-134 and/or calendaring server application 112 can determine whether the user 150 is calm, whether the user 150 is feeling stress, whether the user 150 is anxious, whether the user 150 irritated, whether the user 150 is angry, whether the user 150 is sad, and so on. Based on such determinations, the client devices 130-134 and/or calendaring server application 112 can generate the sentiment parameters and store the sentiment parameters in the user's user profile data 114. The calendaring server application 112 also can access and process the sentiment parameters to determine triggering events and alerts 190 for the future events 122, as will be described in further detail.

To determine the sentiment(s) of the user 150, in one arrangement, the client devices 130-134 (e.g., the calendaring client applications 140-144) and/or the calendaring server application 112 can perform sentiment analysis on images of the user 150 captured by one or more of the client devices 130-134 using respective image capture devices (e.g., cameras). In the case that the calendaring server application 112 performs the sentiment analysis, the client device(s) 130-134 can communicate captured images to the calendaring server application 112. The sentiment analysis can identify facial expressions and/or body language of the user 150 depicted in the images, using techniques known to those of ordinary skill in the art, to determine the user's sentiment based on the facial expressions and/or body language.

In another arrangement, to determine the sentiment(s) of the user 150, the client devices 130-134 (e.g., the calendaring client applications 140-144) and/or the calendaring server application 112 can perform sentiment analysis on audio (e.g., spoken utterances) generated by the user 150 and captured by the client device(s) 130-134 using respective input audio transducers (e.g., microphones). In the case that the calendaring server application 112 performs the sentiment analysis, the client device(s) 130-134 can communicate captured audio to the calendaring server application 112. The sentiment analysis can perform speech recognition on the captured audio to generate corresponding text. Further, the sentiment analysis can analyze the text using techniques known to those of ordinary skill in the art to determine the user's sentiment based on the text. Further, the sentiment analysis can analyze the captured audio using voice tone analysis, which also is known in the art, to determine the user's sentiment based on a tone of the user's voice.

In a further arrangement, to determine the sentiment(s) of the user 150, the client devices 130-134 (e.g., the calendaring client applications 140-144) and/or the calendaring server application 112 can perform sentiment analysis on text generated by, or read by, the user 150 using one or more of the client devices 130-134. In the case that the calendaring server application 112 performs the sentiment analysis, the client device(s) 130-134 can communicate such text to the calendaring server application 112, or the calendaring server application 112 can otherwise access electronic communications sent to or sent by the user 150. Again, the sentiment analysis can analyze the text using techniques known to those of ordinary skill in the art to determine the user's sentiment based on the text.

To generate emotional state parameters indicating emotional states of the user 150, the client devices 130-134 (e.g., the calendaring client applications 40-144) and/or calendaring server application 112 can perform any of the above types of sentiment analysis to determine the emotional states of the user 150. The emotional state(s) of the user 150 can be determined for a time period leading up to a future event, for example in a manner similar to that described for determining sentiment parameters. Identifying emotional states based on sentiment analysis also is known to those of ordinary skill in the art.

In addition to generating behavioral parameters, sentiment parameters, and/or emotional state parameters for the user 150, the calendaring server application 112 can generate behavioral parameters, sentiment parameters, and/or emotional state parameters for one or more other people involved in a future event. In illustration, the calendaring server application 112 can receive data from one or more client devices used by the other people involved in the future event 122, and perform behavioral analysis and/or sentiment analysis on such data to generate corresponding behavioral parameters, sentiment parameters and/or emotional state parameters, for example as previously described. In another arrangement, the client devices used by the other people can generate the behavioral parameters, sentiment parameters and/or emotional state parameters. Further, for example in an arrangement in which the user 150 is in proximity to one or more other people (e.g., a child or children), the client devices 130-134 and/or the calendaring server application 112 can generate sentiment parameters and/or emotional state parameters for such other people based on images and/or audio (e.g., spoken utterances) generated by the other people.

The calendaring server application 112 can analyze the various parameters described above to determine an impact such parameters will have on the amount of time the user 150 will need to prepare for the future event 122. In illustration, if the user 150 is taking a child to a doctor appointment, and the child is misbehaving or crying, it may take more time for the user to prepare herself and the child for the doctor appointment. Similarly, if the user 150 is sad or depressed, it may take the user 150 longer to get herself ready for the doctor appointment. The calendaring server application 112 can analyze parameters corresponding to such circumstances in order to take them into consideration when determining triggering events that initiate presentation of the alert 190 to the user 150 to notify the user of the future event 122. In this regard, the calendaring server application 112 can analyze contexts of precursory tasks 116 (e.g., getting ready for a future event 122), and their impact on the user's schedule, to determine the alert 190, and determine the triggering event which causes the calendaring server application 112 to initiate presentation of the alert 190 to the user 150.

Further, the calendaring server application 112 can identify one or more conditions impacting travel of the user 150 to the location of the future event 122. One or more of the conditions can be external conditions, such as weather conditions, traffic conditions and/or air travel conditions. In illustration, the calendaring server application 112 can communicate with one or more other systems (not shown) to determine weather conditions, traffic conditions and/or air travel conditions, access and/or generate corresponding parameters, and process the parameters to determine an impact such conditions will have on the amount of time it takes the user to travel between various locations in order to arrive at a location of the future event 122. The calendaring server application 112 also can analyze parameters corresponding to such circumstances in order to take them into consideration when determining the alert 190 and the triggering event indicating when the alert 190 should be presented to the user 150 to notify the user of the future event 122. In this regard, the calendaring server application 112 can analyze contexts of various conditions, and their impact on the user's schedule, to determine the alert 190, and determine the triggering event which causes the calendaring server application 112 to initiate presentation of the alert 190 to the user 150.

In sum, the calendaring server application 112 can determine an alert 190 for a future event 122, and a triggering event that initiates presentation of the alert 190 to the user 150, based on one or more precursory tasks 116 that may need to be completed prior to, or as part of, the future event 122 and the time anticipated for the user 150 to complete the precursory task(s) 116. The time anticipated for the user 150 to complete the precursory task(s) 116 may be based on one or more other people involved in the precursory task(s) 116 and/or the future event 122, the sentiment and/or emotional state of the user 150 and/or the other person or people, context of the precursory task(s) 116, various locations, including a location of the future event 122, the user 150 may travel from or to in order to perform the precursory task(s) 116, and so on. As noted, such information can be determined by analyzing the behavior, sentiment, etc. of the user 150 in performing the precursory tasks 116 for the future event 122, as well as conditions impacting travel of the user 150 to a location of the future event 122.

The calendaring server application 112 can perform the previously described analyses using cognitive analysis. In one arrangement, rather than the calendaring server application 112 performing each of the various analyses, the calendaring server 110 can interface with a cognitive system, such as IBM Watson®, and task the cognitive system with performing one or more of the analyses for the calendaring server application 112. As part of the cognitive analysis, the calendaring server application 112 or other cognitive system can create a multi-dimensional matrix with various information related to events 122, 124, such as calendar/schedule entries, precursory tasks/workflows, people involved, and expected milestones. The cognitive analyses can analyze the multi-dimensional matrix to determine various analytic results described herein.

In one aspect of the present arrangements, more than one alert 190 can be presented to the user 150. For example, the calendaring server application 112 can generate alerts 190 prompting the user 150 to perform various precursory tasks 116 the user may need to perform in order to participate in a future event 122. In illustration, based on the contextual information for a future event 122, for example a category to which the future event 122 is assigned, the calendaring server application 112 can determine one or more precursory tasks 116 that the user 150 may need to complete in order to participate in the future event 122. Further, based on the contextual information for the precursory tasks 116, the calendaring server application 112 can determine an order of the precursory tasks 116 are performed and an amount of time anticipated for the user to perform each precursory task 116.

In illustration, the calendaring server application 112 can analyze each precursory task 116 (or workflow items) in reverse order with respect to the future event 122 and determine an anticipated time for the user 150 to complete each precursory task 116. In each analysis, the calendaring server application 112 can process various parameters indicating one or more sentiments and/or emotions of the user 150 affecting the time it will take the user 150 to perform each precursory task 116. Optionally, the calendaring server application 112 also can process various parameters indicating one or more sentiments and/or emotions one or more other people, involved in each precursory task 116, affecting the time it will take the user 150 to perform each precursory task 116. Further, the calendaring server application 112 can process parameters indicating various conditions (e.g., weather conditions, traffic conditions, air travel conditions, etc.) that also affect the time it will take the user 150 to perform each precursory task 116.

Based on the anticipated times for the user 150 to complete each precursory task 116, the calendaring server application 112 can determine, for each precursory task 116, an alert 190 and a triggering event that initiates presentation of the alert 190 to the user 150. The alert 190 for each precursory task 116 can notify the user 150 of an indication to proceed with performance of the precursory task 116.

In illustration, assume the precursory tasks 116 include the user 150 getting ready, driving to a school to pick up a child, and driving to a location of a doctor appointment. Also assume that, based on the various parameters, the calendaring server application 112 determines it will take the user 150 thirty minutes to get ready, fifteen minutes to drive to the school and pick up the child, and ten minutes to drive to the doctor's office. In this example, the calendaring server application 112 can total the respective times to determine the user 150 should begin getting ready fifty five minutes before the scheduled time of the future event 122. Thus, the calendaring server application 112 can determine an alert 190 that notifies the user 150 to begin getting ready for the doctor appointment and schedule a triggering event that initiates the alert 190 at fifty five minutes before the scheduled time of the future event 122. Further, the calendaring server application 112 can determine one or more additional alerts 190 notifying the user 150 when the user is to begin getting ready, and communicate such alerts 190 at predefined intervals before the triggering event (e.g., thirty minutes before the user 150 is to begin getting ready, fifteen minutes before the user 150 is to begin getting ready, and so on.)

Continuing with the previous example, the calendaring server application 112 can determine an alert 190 that notifies the user 150 to leave to pick up the child and schedule a triggering event that initiates the alert 190 at twenty five minutes before the scheduled time of the future event 122. Further, the calendaring server application 112 can determine an alert 190 that notifies the user 150 to proceed traveling to the location of the doctor appointment and schedule a triggering event that initiates the alert 190 at ten minutes before the scheduled time of the future event 122.

In this regard, the calendaring server application 112 can determine how many alerts 190 are to be presented to the user 150 for the future event 122 based on precursory tasks 116 that may need to be completed, when each of such alerts 190 are to be presented based on the precursory tasks 116, and initiate presentation of the alerts 190 at the determined times by defining various triggering events relating to the respective precursory tasks 116.

The following is an example of a use case for the present arrangements. Assume that for at least one past event 124, the user 150 travelled to a remote location via air travel, and the calendaring server application 112 categorized the past event 124. Also, assume that three days prior to the past event 124 the user 150 travelled to a dry cleaning establishment, for instance to deliver clothing that will be used on the trip for dry cleaning. One day prior to the past event 124, the user 150 again travelled to the dry cleaning establishment to retrieve the clothing. Using cognitive analysis, the calendaring server application 112 can generate behavioral parameters based on such actions, analyze the behavioral parameters, generate a behavioral profile based on such analysis, and store the behavioral profile in the user profile data 114. The behavioral profile can indicate that dropping of the clothing to the dry cleaning establishment and picking up the clothing from the dry cleaning establishment are precursory tasks related to the past event 124. Further, the calendaring server application 112 can associate the behavioral profile with a category to which the past event 124 is assigned.

In one arrangement, the user 150 may have scheduled future events 122 in an electronic calendar indicating that the user 150 was dropping off clothing on a certain day and picking up clothing on a certain day. The future events 122 may be completed and become past events 124. In such cases, the calendaring server application 112 can process the events 122, 124 to determine contexts for the events 122, 124, and assign the precursory tasks 116 to respective categories based on such contexts. In another arrangement, the calendaring server application 112 can infer contexts for the events 122, 124 using cognitive processing. For example, based on a myriad of previously received data, the cognitive processing can indicate that people typically pick up clothes from dry cleaners two days after dropping the clothes off. Thus, the calendaring server application 112 can infer that when there are two trips to a particular dry cleaner in a two day period, the first trip was to drop off clothes and the second trip is to pick up the clothes.

Continuing with the previous example, assume the user 150 has a future event 122 for which the user 150 needs to travel to a remote location via air travel. The calendaring server application 112 can determine, based on an analysis of the event data 120 corresponding to the future event 122, that the future event 122 is assigned to a same category as the past event 124. Accordingly, the calendaring server application 112 can determine that precursory tasks 116 of dropping off clothing to the dry cleaners and picking up the clothing from the dry cleaners may need to be completed prior to the user 150 traveling to the future event 122. Accordingly, the calendaring server application 112 can determine triggering events for each precursory task 116 that, in response to being detected, cause the calendaring server application 112 to initiate respective alerts 190 for the precursory task 116. In illustration, three days prior to the future event 122, the calendaring server application 112 can initiate an alert 190 to the user 150 notifying the user 150 to deliver clothing to the dry cleaner. Also, one day prior the future event 122, the calendaring server application 112 can initiate an alert 190 to the user 150 notifying the user 150 to retrieve the clothing from the dry cleaner. Further, on the day of the future event 122, the calendaring server application 112 can communicate an alert 190 to the user 150 to prompt the user 150 to commence travel to an airport. The calendaring server application 112 can determine a triggering event for such notification to be an adequate amount of time before the flight to account for various parameters previously described and still ensure the user 150 reaches the airport in time to board the plane.

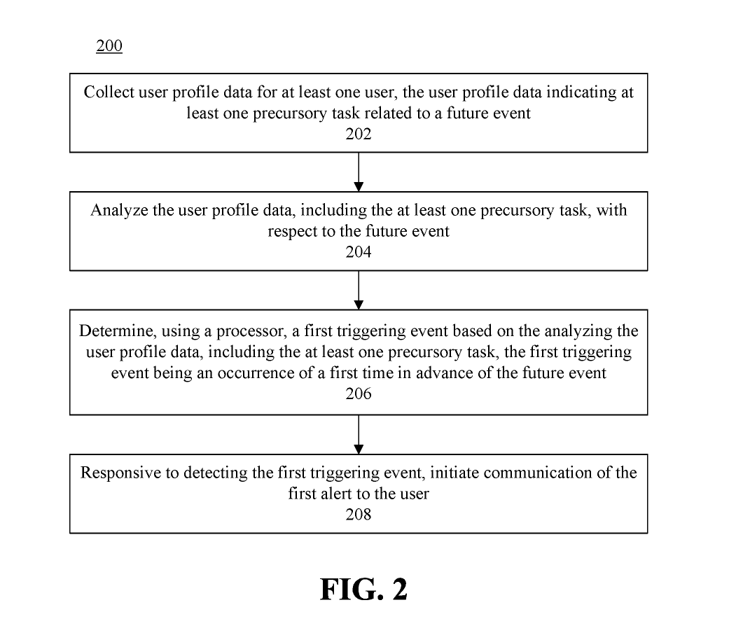

FIG. 2 is a flow chart illustrating an example of a method 200 of communicating to a user 150 an alert 190 for a future event 122. At step 202, the calendaring server application 112 can collect user profile data 114 for at least one user 150, the user profile data 114 indicating at least one precursory task 116 related to a future event 122. At step 204, the calendaring server application 112 can analyze the user profile data 114, including the at least one precursory task 116, with respect to the future event 122. At step 206, the calendaring server application 112 can determine, using a processor, a first triggering event based on the analyzing the user profile data 114, including the at least one precursory task 116, the first triggering event being an occurrence of a first time in advance of the future event 122. At step 208, the calendaring server application 112 can, responsive to detecting the first triggering event, initiate communication of the first alert 190 to the user 150.

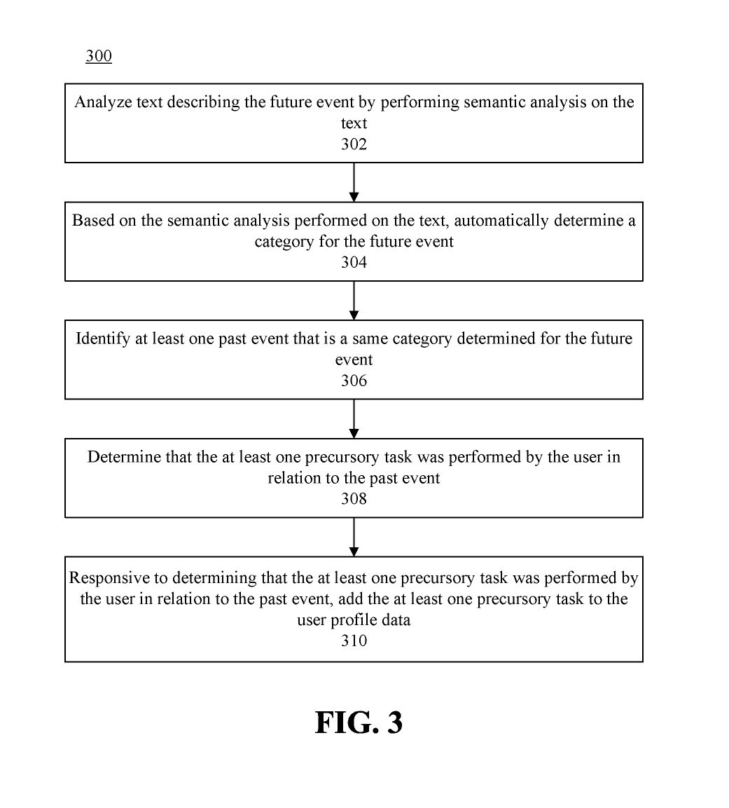

FIG. 3 is a flow chart illustrating an example of a method 300 of adding a precursory task 116 to user profile data 114. At step 302, the calendaring server application 112 can analyze text describing the future event 122 by performing semantic analysis on the text. At step 304, the calendaring server application 112 can, based on the semantic analysis performed on the text, automatically determine a category for the future event 122. At step 306, the calendaring server application 112 can identify at least one past event 124 that is a same category determined for the future event 122. At step 308, the calendaring server application 112 can determine that the at least one precursory task 116 was performed by the user 150 in relation to the past event 124. At step 310, the calendaring server application 112 can, responsive to determining that the at least one precursory task 116 was performed by the user 150 in relation to the past event 124, add the at least one precursory task 116 to the user profile data 114.

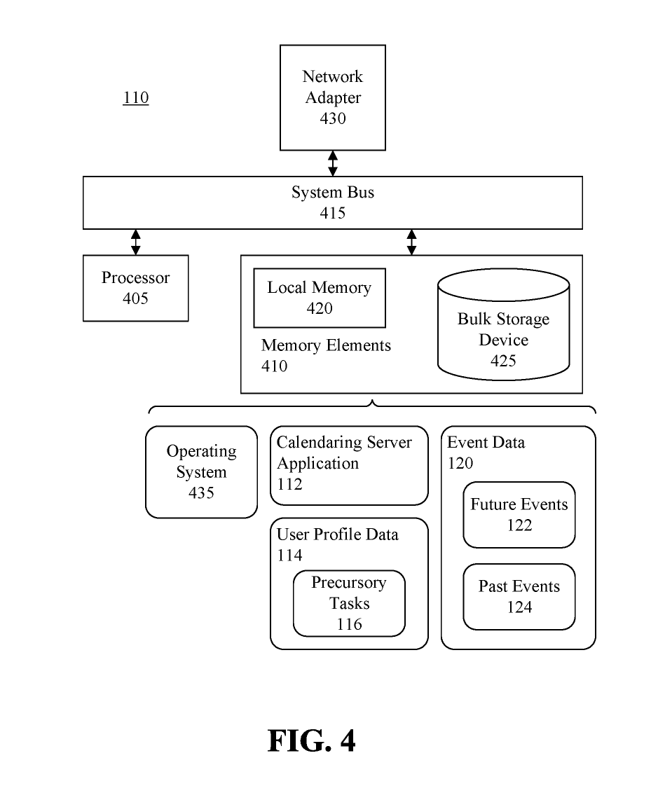

FIG. 4 is a block diagram illustrating example architecture for the calendaring server 110. The calendaring server 110 can include at least one processor 405 (e.g., a central processing unit) coupled to memory elements 410 through a system bus 415 or other suitable circuitry. As such, the calendaring server 110 can store program code within the memory elements 410. The processor 405 can execute the program code accessed from the memory elements 410 via the system bus 415. It should be appreciated that the calendaring server 110 can be implemented in the form of any system including a processor and memory that is capable of performing the functions and/or operations described within this specification. For example, the calendaring server 110 can be implemented as a server, a plurality of communicatively linked servers, and so on.

The memory elements 410 can include one or more physical memory devices such as, for example, local memory 420 and one or more bulk storage devices 425. Local memory 420 refers to random access memory (RAM) or other non-persistent memory device(s) generally used during actual execution of the program code. The bulk storage device(s) 425 can be implemented as a hard disk drive (HDD), solid state drive (SSD), or other persistent data storage device. The calendaring server 110 also can include one or more cache memories (not shown) that provide temporary storage of at least some program code in order to reduce the number of times program code must be retrieved from the bulk storage device 425 during execution.

At least one network adapters 430 can be coupled to calendaring server 110 to enable the calendaring server 110 to become coupled to other systems, computer systems, remote printers, and/or remote storage devices through intervening private or public networks. Modems, cable modems, transceivers, and Ethernet cards are examples of different types of network adapters 445 that can be used with the calendaring server 110.

As pictured in FIG. 4, the memory elements 410 can store the components of the calendaring server 110 of FIG. 1, namely an operating system 435, the calendaring server application 112, the user profile data 114, including the precursory tasks 116, and the event data 120, including data for the future events 122 and the past events 124. Being implemented in the form of executable program code, the operating system 435 and the calendaring server application 112 can be executed by the calendaring server 110 and, as such, can be considered part of the calendaring server 110. Moreover, the user profile data 114 and the event data 120 are functional data structures that impart functionality when employed as part of the calendaring server 110. Further, executing the calendaring server application 112, the calendaring server 110 can output various data, for example, the user profile data 114, the event data 120, and the alerts 190 of FIG. 1.

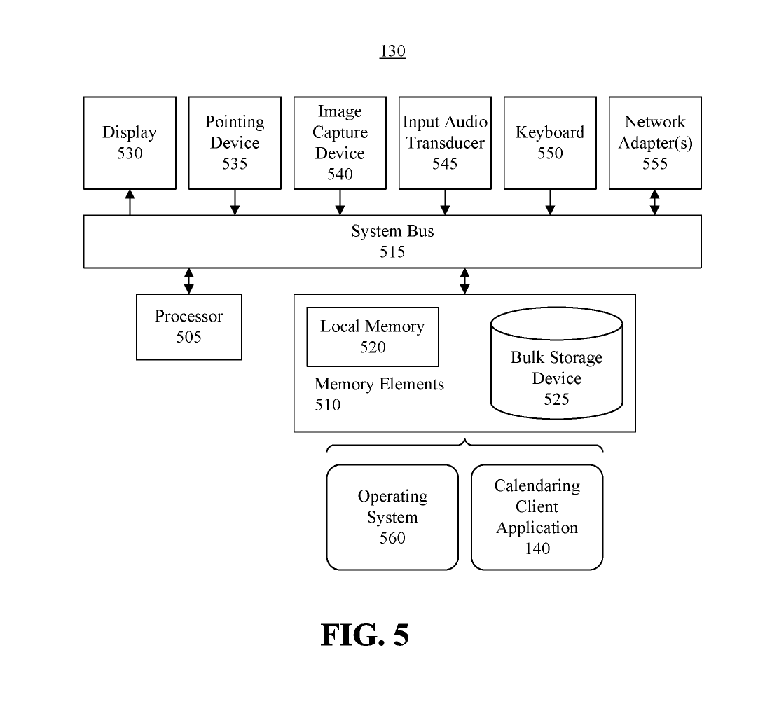

FIG. 5 is a block diagram illustrating example architecture for the client device 130. The client devices 132, 134 can include a similar architecture. The client device 130 can include at least one processor 505 (e.g., a central processing unit) coupled to memory elements 510 through a system bus 515 or other suitable circuitry. As such, the client device 130 can store program code within the memory elements 510. The processor 505 can execute the program code accessed from the memory elements 510 via the system bus 515.

The memory elements 510 can include one or more physical memory devices such as, for example, local memory 520 and one or more bulk storage devices 525. The client device 130 also can include one or more cache memories (not shown) that provide temporary storage of at least some program code in order to reduce the number of times program code must be retrieved from the bulk storage device 525 during execution.

Input/output (I/O) devices such as a display 530, a pointing device 535, an image capture device (e.g., camera) 540, an input audio transducer (e.g. microphone) 545 and, optionally, a keyboard 550, can be coupled to the data processing system 400. The I/O devices can be coupled to the client device 130 either directly or through intervening I/O controllers. For example, the display 530 can be coupled to the client device 130 via a graphics processing unit (GPU), which may be a component of the processor 505 or a discrete device. One or more network adapters 555 also can be coupled to client device 130 to enable the client device 130 to become coupled to other systems, computer systems, remote printers, and/or remote storage devices through intervening private or public networks. Modems, cable modems, transceivers, and Ethernet cards are examples of different types of network adapters 555 that can be used with the data processing system 500.

As pictured in FIG. 5, the memory elements 510 can store the components of the client device 130 of FIG. 1, namely an operating system 560 and the calendaring client application 140. Being implemented in the form of executable program code, these components of the client device 130 can be executed by the client device 130 and, as such, can be considered part of the client device 130.

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” or similar language means that a particular feature, structure, or characteristic described in connection with the embodiment is included in at least one embodiment described within this disclosure. Thus, appearances of the phrases “in one embodiment,” “in an embodiment,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
collecting user profile data for at least one user, the user profile data indicating at least one precursory task related to a future event;
analyzing the user profile data, including the at least one precursory task, with respect to the future event;
determining, using a processor, a first triggering event based on the analyzing the user profile data, including the at least one precursory task, the first triggering event being an occurrence of a first time in advance of the future event; and
responsive to detecting the first triggering event, initiating communication of a first alert to the user.

2. The method of claim 1, further comprising:
analyzing text describing the future event by performing semantic analysis on the text;
based on the semantic analysis performed on the text, automatically determining a category for the future event;
identifying at least one past event that is a same category determined for the future event;
determining that the at least one precursory task was performed by the user in relation to the past event; and
responsive to determining that the at least one precursory task was performed by the user in relation to the past event, adding the at least one precursory task to the user profile data.

3. The method of claim 1, wherein the first time in advance of the future event is determined based on a duration of time anticipated for the user to perform the at least one precursory task.

4. The method of claim 3, wherein the duration of time anticipated for the user to perform the at least one precursory task is based on at least one person, in addition to the user, involved in the precursory task.

5. The method of claim 1, wherein the first time in advance of the future event is determined based on a location of the future event and at least one condition impacting travel of the user to the location of the future event.

6. The method of claim 5, wherein the at least one condition impacting travel of the user to the location of the future event is an external condition selected from a group consisting of at least one weather condition, at least one traffic condition and at least one air travel condition.

7. The method of claim 1, wherein:
the user profile data further includes at least one parameter selected from a group consisting of a behavioral parameter indicating a behavior of the user, a sentiment parameter indicating a sentiment of the user, and an emotional state parameter indicating an emotional state of the user; and
analyzing the user profile data includes analyzing the at least one parameter.

8. The method of claim 1, wherein the at least one precursory task comprises a plurality of precursory tasks, the method further comprising:
determining at least a second triggering event based on the analyzing the user profile data, including the plurality of precursory tasks, the second triggering event being an occurrence of a second time in advance of the future event and initiating a second alert for the future event, the second alert notifying the user to proceed with performance of a second of the plurality of precursory tasks; and
responsive to detecting the second triggering event, communicating the second alert to the user.

9. A system, comprising:
a processor programmed to initiate executable operations comprising:
collecting user profile data for at least one user, the user profile data indicating at least one precursory task related to a future event;
analyzing the user profile data, including the at least one precursory task, with respect to the future event;
determining a first triggering event based on the analyzing the user profile data, including the at least one precursory task, the first triggering event being an occurrence of a first time in advance of the future event; and
responsive to detecting the first triggering event, initiating communication of a first alert to the user.

10. The system of claim 9, the executable operations further comprising:
analyzing text describing the future event by performing semantic analysis on the text;
based on the semantic analysis performed on the text, automatically determining a category for the future event;
identifying at least one past event that is a same category determined for the future event;
determining that the at least one precursory task was performed by the user in relation to the past event; and
responsive to determining that the at least one precursory task was performed by the user in relation to the past event, adding the at least one precursory task to the user profile data.

11. The system of claim 9, wherein the first time in advance of the future event is determined based on a duration of time anticipated for the user to perform the at least one precursory task.

12. The system of claim 11, wherein the duration of time anticipated for the user to perform the at least one precursory task is based on at least one person, in addition to the user, involved in the precursory task.

13. The system of claim 9, wherein the first time in advance of the future event is determined based on a location of the future event and at least one condition impacting travel of the user to the location of the future event.

14. The system of claim 13, wherein the at least one condition impacting travel of the user to the location of the future event is an external condition selected from a group consisting of at least one weather condition, at least one traffic condition and at least one air travel condition.

15. The system of claim 9, wherein:
the user profile data further includes at least one parameter selected from a group consisting of a behavioral parameter indicating a behavior of the user, a sentiment parameter indicating a sentiment of the user, and an emotional state parameter indicating an emotional state of the user; and
analyzing the user profile data includes analyzing the at least one parameter.

16. The system of claim 9, wherein the at least one precursory task comprises a plurality of precursory tasks, the executable operations further comprising:
determining at least a second triggering event based on the analyzing the user profile data, including the plurality of precursory tasks, the second triggering event being an occurrence of a second time in advance of the future event and initiating a second alert for the future event, the second alert notifying the user to proceed with performance of a second of the plurality of precursory tasks; and
responsive to detecting the second triggering event, communicating the second alert to the user.

17. A computer program product comprising a computer readable storage medium having program code stored thereon, the program code executable by a processor to perform a method comprising:
collecting, by the processor, user profile data for at least one user, the user profile data indicating at least one precursory task related to a future event;
analyzing, by the processor, the user profile data, including the at least one precursory task, with respect to the future event;
determining, by the processor, a first triggering event based on the analyzing the user profile data, including the at least one precursory task, the first triggering event being an occurrence of a first time in advance of the future event; and
responsive to detecting the first triggering event, initiating, by the processor, communication of a first alert to the user.

18. The computer program product of claim 17, the method further comprising:
analyzing text describing the future event by performing semantic analysis on the text;
based on the semantic analysis performed on the text, automatically determining a category for the future event;
identifying at least one past event that is a same category determined for the future event;
determining that the at least one precursory task was performed by the user in relation to the past event; and
responsive to determining that the at least one precursory task was performed by the user in relation to the past event, adding the at least one precursory task to the user profile data.

19. The computer program product of claim 17, wherein the first time in advance of the future event is determined based on a duration of time anticipated for the user to perform the at least one precursory task.

20. The computer program product of claim 19, wherein the duration of time anticipated for the user to perform the at least one precursory task is based on at least one person, in addition to the user, involved in the precursory task.
